(19) United States
(12) Patent Application Publication
(10) Pub. No.: US 2014/0229313 A1
(43) Pub. Date: Aug. 14, 2014

(54) MULTISTAGE AUCTION PROCESS AND SYSTEM WITH FLAT RATE ENTRY FEE

(71) Applicant: KEVIN SHIMIZU, SAN JUAN CAPISTRANO, CA (US)

(72) Inventor: KEVIN SHIMIZU, SAN JUAN CAPISTRANO, CA (US)

(21) Appl. No.: 13/765,647

(22) Filed: Feb. 12, 2013

(51) Int. Cl. G06Q 30/08

(52) U.S. Cl. CPC G06Q 30/08
USPC 705/26.3

(57) ABSTRACT

A system and method use a protocol implementing a competitive auction with a flat rate entry fee. A user is credited with a preselected, maximum number, of bids per auction. In an initial “warm up” stage, users can join the auction. The auction price decreases when new users join the auction during this stage, as by 0.5%. In an “active stage,” bids are placed within temporal bid windows. Each bid placed decreases the auction price. In a lockout stage, new users are not allowed. A bid window timer remains active. Each user's username is displayed along with each bid. The final bid is the bid that has been placed when the bid window timer expires, and is the winning bid. A strategy is enabled wherein a bidder can receive an item for a reduced price, while not having to place an unlimited number of bids.

### CROSS-REFERENCE TO RELATED APPLICATIONS

This application claims priority from provisional application Ser. No. 61/717,532 entitled Multistage Auction Process and System with Flat Rate Entry Fee filed on Oct. 23, 2012. The contents of this provisional application are fully incorporated herein by reference.

### BACKGROUND

1. Field

The present subject matter relates to a competitive trading protocol and system for the presentation and sale or trade of at least one item and having predefined rules for bid submission, bid consideration, and winner determination.

2. Background

A significant form of trading protocol is the online auction. The online auction provides an efficient way of presenting items to users, considering offers on items, and closing sales. The “standard” auction protocol is typified by the eBay® auction. An item is posted on an auction site. The trading protocol accepts sequentially increasing bids. When a bidding period times out, the highest bidding user “wins” the auction. In other words, the user's offer to buy is accepted. This protocol follows the model of a traditional auction. It does not provide for variations on the auction theme, e.g., providing discounts, in order to attract users operating on a different business model from the traditional sale.

An alternative form of auction is known as the “penny auction.” An example is the Quibids® auction. In one preferred form of employing this protocol, a popular consumer goods item is posted with an extremely low opening price. Each time a user places a bid, the auction price is incremented by a small amount, e.g., $0.01. However, the user must pay a non-trivial fee, e.g., $0.50, to place each bid. “Non-trivial” is measured in relation to the business model set by the auctioneer to optimize the size of the bid fee versus the attractiveness of paying bid fees. Bids are placed during a bid window, which may have an initial duration of 70 seconds. After a selected numbers of bids, the bid window timer will set successively smaller bid windows. The “winning user” is the last user to place a bid before the bid window expires.

In one example, the popular consumer goods item is a tablet computer, having a retail price of $600. A user wins when the bid time expires, and the auction price is, for example, $60. The price paid by the user is the $60 auction price plus the total value of the bid fees. If the winning user has used 10 bids at $0.50 each, the total value of the bid fees is five dollars, and the total purchase price is $65. In this example, the auction price of $60 represents 6000 increments of $0.01 each. Achieving a total of 6000 increments requires the submission of 6000 bids. This represents a good value proposition for the auctioneer. The auctioneer grosses $3060 on the auction, and deducts its cost of the tablet computer to arrive at a gross profit of $2460.

The value proposition for the users is very different. It is statistically unlikely for a user to win an auction using only 10 bids. Experience has shown that users can use hundreds or even thousands of bids, and still not win an auction. Consequently, the value proposition here takes on a gaming aspect, and is not attractive to more conservative users.

### SUMMARY

Briefly stated, in accordance with the present subject matter, a system and method are provided employing a protocol in which a user pays a flat fee to join an auction, and receives a limited number of opportunities to place a bid. One of the features of the present subject matter is that a distinct technique is used to generate an auction price based on the actions of an auction company, and of users participating in an auction. Another feature is that a distinct definition of the auctioned item is used.

The auction's opening price is set at a preselected percentage of retail, or other measurable price of an item. As bids are placed, the price of the item is decreased by a predetermined amount based on the item's retail price. The auctioned item does not need to be a single object, and may comprise of a group of items from which the winning user may select one item.

The present protocol provides for various successive auction stages, which affect the pricing and competitiveness of the auction. The stages may include an initial “warm up” stage, an “active” stage, and a “lockout” stage.

A warm up stage begins when the auction opens. It is an initial stage, which could last 15 to 45 minutes in which users can join the auction. During this stage, there is no active bid window timer. Therefore, there can be no winner in this stage. However, participants are still allowed to bid to drive the auction price down. Also during this stage, the item auction price is decreased, e.g., as by 0.5%, each time a new user joins the auction. This is known as the “New User Discount.”

An active stage may have a 30 to 120 minute duration. A bid window timer becomes active, which defines the bid windows. A first bid window may be 15 seconds, and the bid window may be shortened through the duration of the active stage. Bid windows of differing duration may be provided during different portions of an auction. In a lockout stage, new users are not allowed to join the auction. The bid window timer remains active, and each bidder's username is displayed with each bid placed.

Providing a system and method for utilizing the present protocol provides the opportunity for a reduced price of an item. Providing a limited number of bids allows a user to employ strategy when placing each bid. The flat fee per auction allows a user to calculate cost exposure prior to entering an auction.

### BRIEF DESCRIPTION OF THE DRAWINGS

FIG. 1 is a block diagram of a nominal online auction system in which the present subject matter is implemented;

FIG. 2 is a flowchart illustrating the auction process in which users join an auction;

FIG. 3 and FIG. 4 are flowcharts illustrating the auction process;

FIG. 5, consists of FIG. 5A, which is a flowchart illustrating an end routine which commences when the bidding is over, and FIG. 5B, which is an auction review page;

FIG. 6 is a block diagram of a processor used for implementing the present subject matter;

FIG. 7 is a diagram of an auction dashboard;

FIG. 8 is a diagram of an auction homepage; and

FIG. 9 is an illustration of an auction bid page.

### DETAILED DESCRIPTION

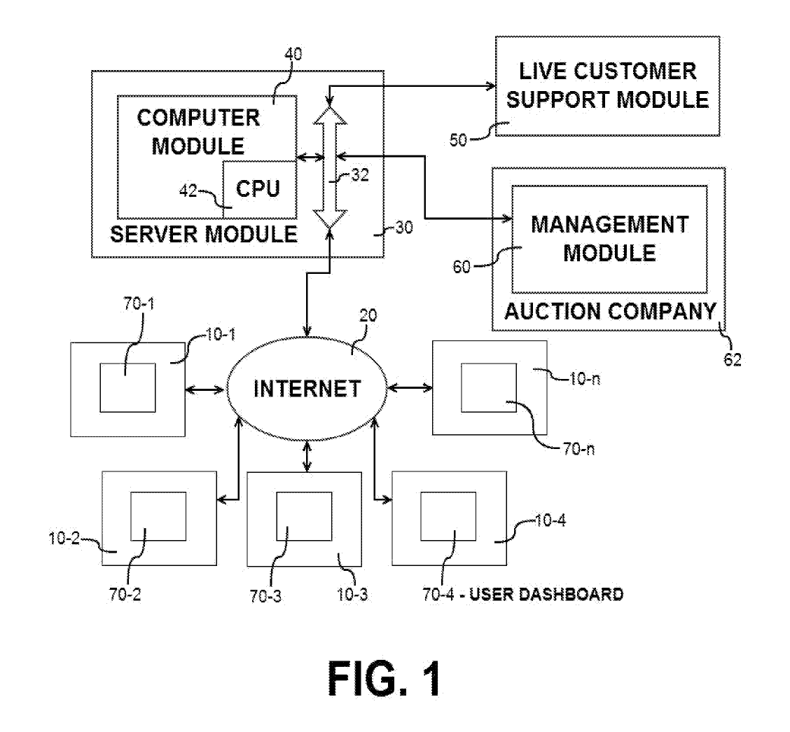

FIG. 1 is a block diagram of a nominal online auction system in which the present subject matter is implemented. A number of users, collectively referred to as users 10, may interact via a network such as the Internet 20 with a server module 30. The users 10 comprise individual users 10-1, 10-2, 10-3, . . . , 10-n, where n is an integer. For purposes of the present description, the term “user” represents a person or other entity capable of communicating with the server module 30. As further discussed below, the auctioned item may comprise of a group of items from which the winning user may select one item. A bidder is a user 10 who is participating in the auction process and currently has the ability to place a bid.

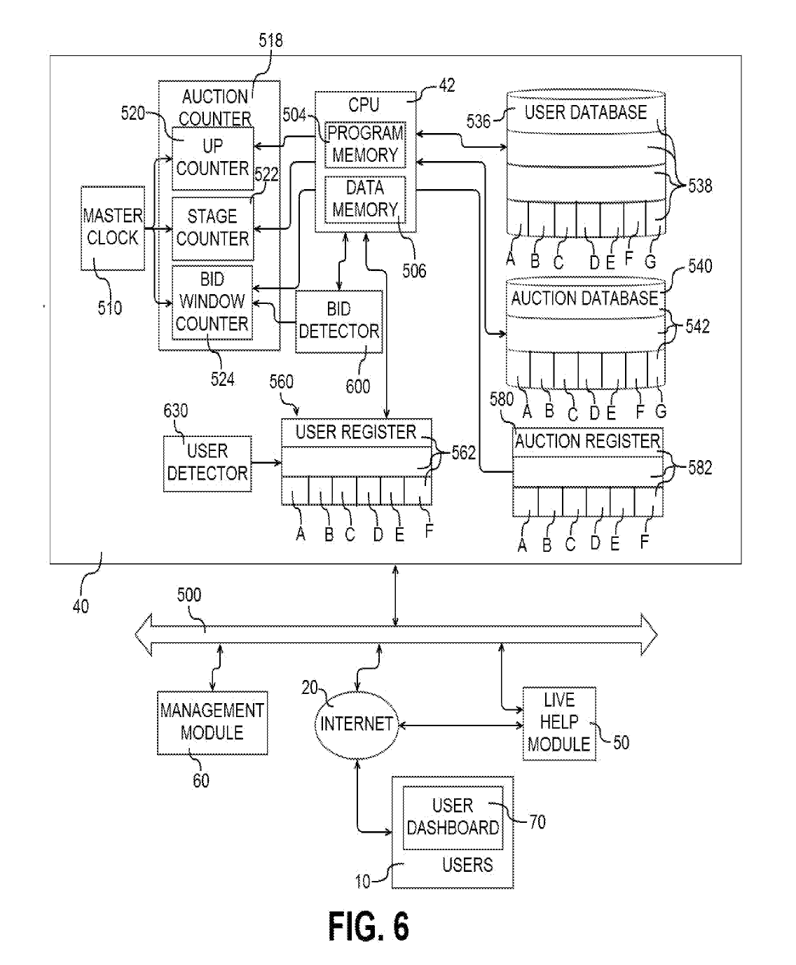

The server module 30 comprises a digital bus 32 interconnecting various components, which include the following. A computer module 40 allows users 10 to interact in accordance with an auction protocol. A central processing unit (CPU) 42 in the computer module 40 performs calculations and other operations commanded by programs running on the computer module 40. A live customer support module 50 interfaces customer service representatives with communications from users 10. A management module 60 allows an auction company 62 to control auction operations, to define handling of customer accounts, to set auction parameters, and to schedule and conduct auctions. Auction information is sent to a user dashboard 70 at each user 10. The management module 60 provides information and values to the various registers and settable components, as further described with respect to FIG. 6 below.

The present description will address the basic methods utilized in accordance with the present subject matter, hardware on which the methods are implemented, interfaces with users, and further embodiments and variations.

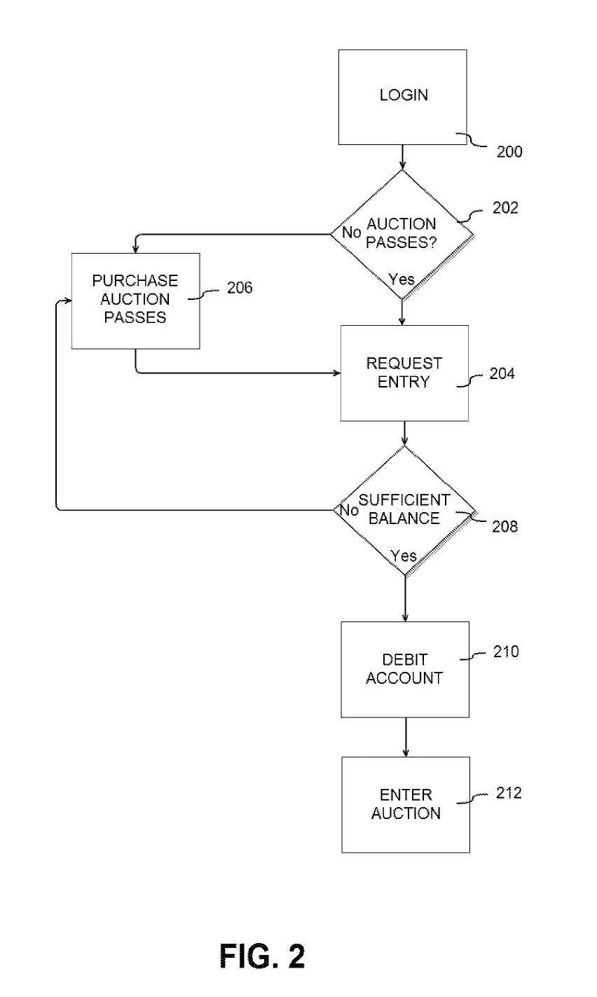

FIG. 2 is a flowchart illustrating the auction process in which users join an auction. In a preferred form, each user 10 pays a fixed, one-time admission fee to enter an auction. As further described below, an account is set up for each user 10. A fee can be charged in cash. Preferably, tokens are used each having a fixed price. In the present description, these tokens are referred to as auction passes. In one form, each Auction Pass costs $5.00. The fixed fee can be set as a function of an auctioned item's retail price. In other words, auctions of a more expensive item will require more auction passes to enter than an auction of a less expensive item.

Auction Passes are used to allow any user to gain entry into an auction. An auction is conducted in accordance with a set of rules. Rules are discussed further below. In one set of auction rules, a user 10 is granted a fixed number of bids that may only be used in one auction. Each user may enter an individual auction only once. However, one user may enter a plurality of concurrent auctions. A limit may be set on the number of auctions one user may enter concurrently, e.g., 6 auctions.

The procedure begins at block 200 where a user logs in. At block 202 a user 10 may elect to proceed to block 206 to buy auction passes. At block 204 a user may select an auction to join. Each auction will have a preselected entry fee of one or more auction passes. At block 208 the system sees if the user account has a balance of a sufficient number of auction passes to enter the selected auction. If so, operation proceeds to block 210, and the appropriate number of passes are debited from a user 10's account. If not, operation proceeds to block 206 where the user purchases further auction passes. From block 206, the user may return to block 204 to request entry into an auction and then proceed via block 208 to block 210 and continue as previously described. At block 212, the user 10 joins the auction. When the user enters the auction, the bid balance in the user account is credited with a fixed number of bids for the current auction, for example, 50 bids. The bids are usable only in the auction for which they are issued. Bids cannot be transferred except in limited circumstances described below.

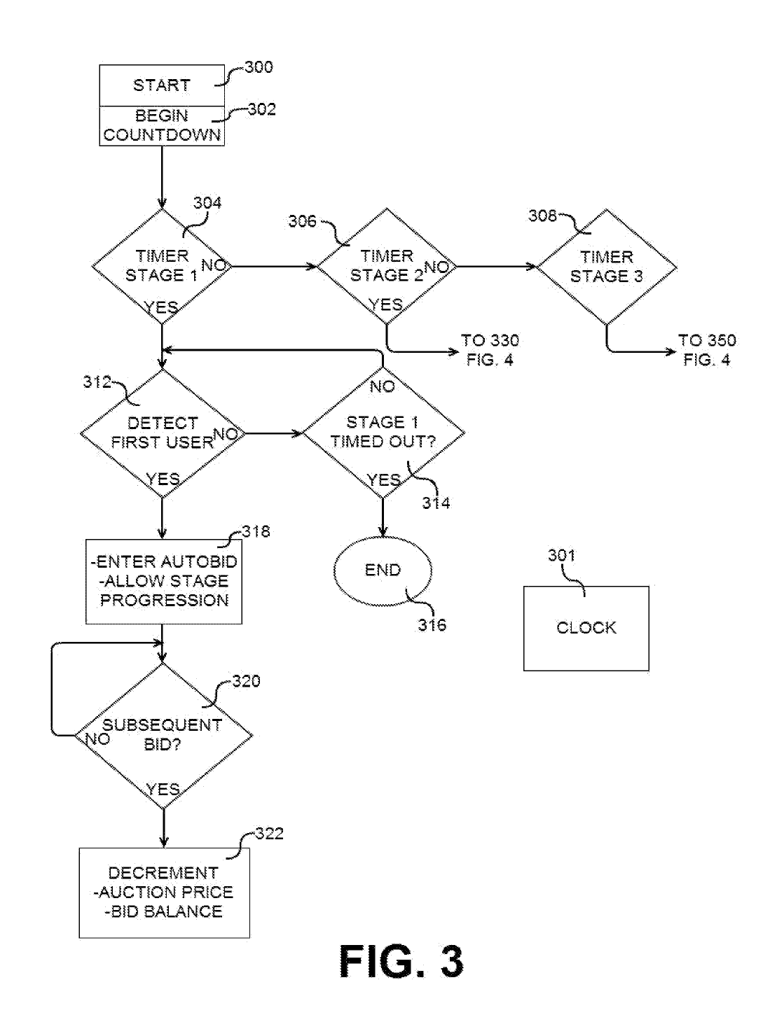

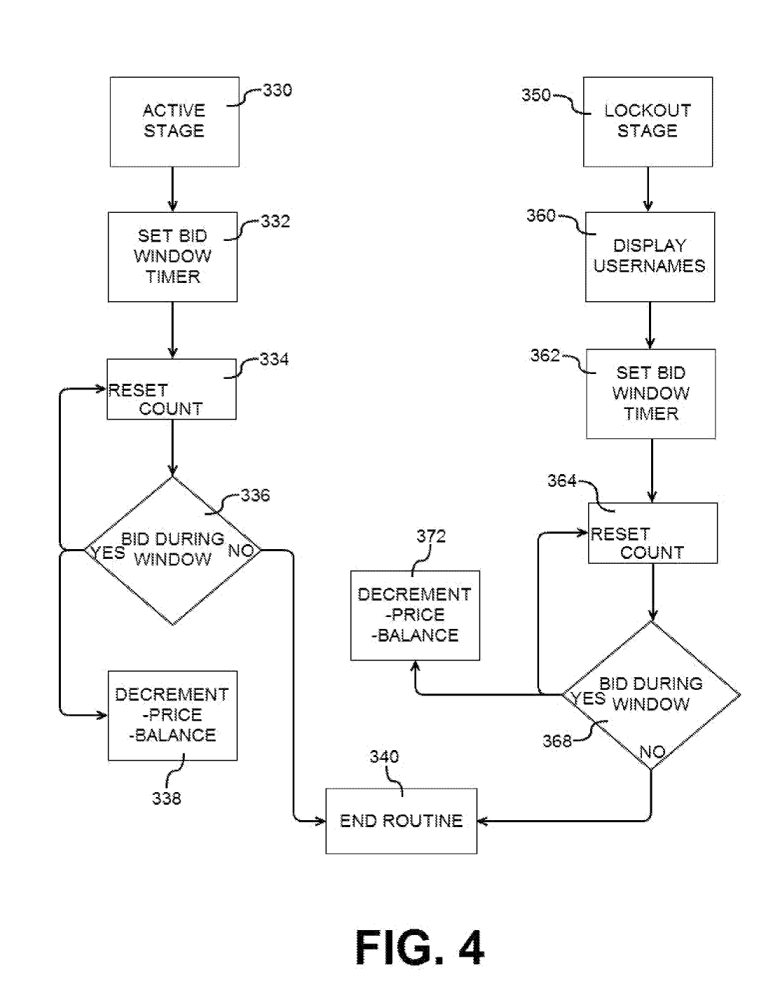

FIG. 3 and FIG. 4 are flowcharts illustrating the auction process. An auction item register, described with respect to FIG. 6 below, is initialized. An opening auction price is set. In one example the auctioned item's starting price is 75% of its retail price. After the first bid, the current auction price level is decremented in response to the placing of additional bids. A nominal range for the size of each decrement may be $0.05 to $0.25. A $0.05 decrement may be utilized in an auction having an entry fee of one auction pass. A $0.25 decrement may be utilized in an auction having a fee of ten auction passes.

The beginning of the auction process is illustrated in FIG. 3. Further stages are illustrated in FIG. 4. The auction has a plurality of stages, e.g., three. Operation proceeds from FIG. 3 to FIG. 4 at the illustrated interfaces. Timing is provided by a system clock 301. The clock provides clock pulses to measure time spans, and to provide clock signals for ordering operations. The auction begins at block 300, entitled Start. The first two stages will have a predetermined maximum duration. The duration may be measured by a countdown auction timer. At block 302, the countdown auction timer is activated to measure the maximum combined duration of the first two stages.

In the present embodiment, three successive time periods are defined. A first period, or stage, may be referred to as a warm-up stage. A second period may be referred to as an active stage. A third period may be referred to as a lockout stage. These titles are arbitrary and simply used as an aid in description. At block 304, elapsed time is compared to a range defining the warm-up stage. If the time indicates the system is in the warm-up stage, operation remains at block 304. If the system is not in the warm-up stage, operation proceeds to block 306. At block 306, elapsed time is compared to the time range for the active stage. If the system is in the active stage, operation proceeds to block 330 in FIG. 4. If not, operation proceeds to block 308.

In the warm-up stage, at block 312, the system periodically determines if a first user has joined the auction. If not, operation proceeds to block 314, where it is determined if the auction has timed out. If so, operation ends at block 316. Block 316 differs from the end routine and block 340 discussed below. Block 316 signifies that since there were no users who joined the auction during the warm up stage, the auction did not commence. If the warm-up stage has not timed out, operation returns to the input of block 312 until a user joins the auction. If so, at block 318 an initial “free” bid is entered and the initial user 10's balance of remaining bids is not debited, and there is no auction price decrement with this bid. Therefore, there will be an auction winner even if no further bids are placed. In addition, at block 318 the auction recognizes the first user's participation, and will allow the auction to progress to the second stage once the Warm Up Timer expires.

The auction process continues from block 318 to block 320, where subsequent bids, if any, are detected. If no bid is detected, operation returns to the input of block 320. If a bid is entered at block 320, then at block 322, the auction price is decremented and a user 10's bid balance is debited by one bid. The price in an auction item's register is updated to reflect a new current auction price. The price updating continues in this manner until an auction is completed as further described below. Following this procedure, after a large number of bids have been placed, the auction price may be decremented to a level below $0.00. If so, the winning user will be paid the final balance. For example, if the final auction price is −$25.00, the winning user will be paid $25.00. In other words, the auction company will pay the winning user the negative auction price. The rules of the auction will provide for a profit by the auction company even in this case.

Bidding will continue in a similar manner in the subsequent stages, as shown in FIG. 4. In accordance with the present subject matter, a set of items may be provided for auction and a winning user may select a preselected number of items, e.g., one item, out of the set.

Operation proceeds from block 304 to block 306. From block 306, operation proceeds to Active Stage block 330, shown in FIG. 4. Operation then continues until the Active Stage times out or a bid window times out. If a bid window has not timed out, and the Active Stage has timed out, operation proceeds from block 306 to block 308. From block 308, operation proceeds to Lockout Stage block 350, shown in FIG. 4.

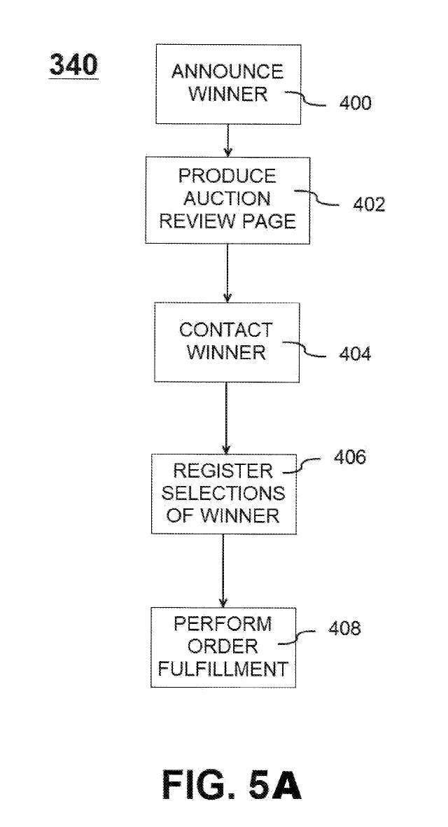

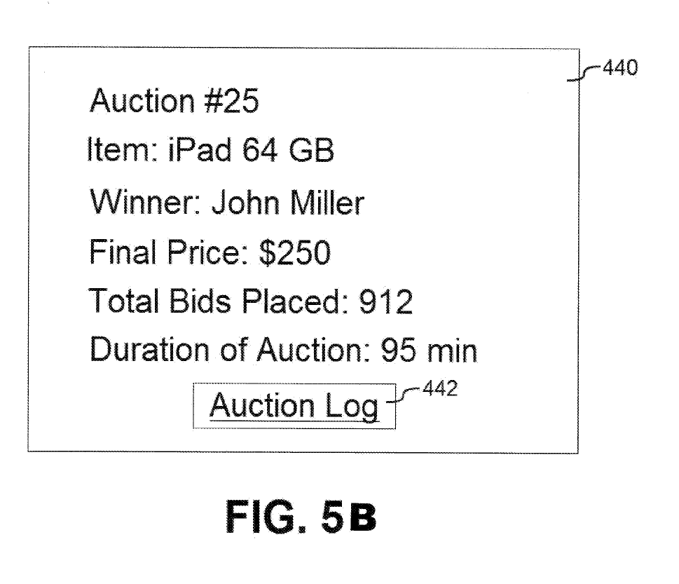

FIG. 4 is a block diagram illustrating the Active Stage, starting at block 330, and the Lockout Stage, starting at block 350. In the Active Stage operation proceeds to block 332. At block 332, the duration of the initial bid window is set. A bid window may be shortened at predetermined intervals during the active stage. A bid window set circuit receives an input from the system clock 301 (FIG. 3). This sets the duration of the bid window in accordance with the preselected changes to the bid window durations during the Active Stage. Along with the initial setting of the bid window duration at block 332, a countdown is initiated at block 334. The countdown is set to equal the preselected bid window durations. At block 336 it is determined if a bid was received during the bid window. If a bid was received, the operation proceeds to block 338, where the price is decremented and the user's bid balance is debited by one bid. Also, the bid window timer is reset at block 334 to await another bid. If no bid is received during the bid window, the last participant to place a bid is the winner, and operation proceeds to the end routine 340. The end routine 340 is illustrated in further detail in FIG. 5A below.

The end of the time period set for the active stage is sensed at block 306, and operation is routed to block 308. When the beginning of the time period of the Lockout Stage is sensed, operation proceeds to the Lockout Stage block 350. At block 360, further information is sent to the user dashboard 70 (FIG. 1). In the present embodiment, this information includes displaying the usernames of bidders with each bid. In this particular illustration, the number of bids remaining in each user 10's balance is not shown. Thus each user 10 cannot factor the remaining number of bids of other users 10 into their respective strategies.

At block 362, a bid window timer is set to define a preselected duration of the bid window during which a bid may be placed during the Lockout Stage. A bid window countdown begins at block 364. At block 368 the system determines if a bid has been received during the bid window. If so, at block 364, the bid window timer is reset. If a bid was received, the operation proceeds to block 372, where the price is decremented and the user's bid balance is debited by one bid. If not, the last user to place a bid is the winner, and operation proceeds to block 340 to the end routine.

FIG. 5A is an illustration of the end routine 340. An auction review page 440 is illustrated in FIG. 5B. The auction review page 440 may be similar to the auction bid page. At block 400 a winner is announced. The auction review page 440 (FIG. 5B) is produced at block 402. The winner is contacted at block 404. As described with respect to FIGS. 3 and 4, the winner may have a number of auctioned items to choose as their prize. The winning user claims the auctioned item by paying the final item auction price. If a winning user is not satisfied with the final item auction price, the purchase may be declined, and the user may receive double auction passes in return. The selected options are registered at block 406. An option which was selected may be displayed on the auction review page 440 (FIG. 5B). At block 408 order fulfillment is executed.

As seen in FIG. 5B, the auction review page 440 includes a log of participant activity. In one preferred form, auction review page 440 has fields that include an auction identification number, item name, winning user, final item auction price, total bids placed, and duration of the auction. In addition, the auction review page 440 will include a link to the auction log 442. The auction log will include additional auction information, such as the time of each bid placed with the bidder's identity, the user's remaining bids at the time the respective bid was placed, when each participant joined the auction, and any New User Discounts. A more detailed description of the auction log, is included below.

FIG. 6 is a block diagram of the computer module 40 and its interconnection in the present system. FIG. 6 illustrates the management module 60 and the users 10 coupled to the server module 30 (FIG. 1) via a data bus 500. The functions represented are not necessarily included in discrete circuit elements. Discrete elements are illustrated for the purpose of simplicity in description. The same or equivalent structure may be provided in a number of ways. The particular structural example illustrated is representative of suitable embodiments. The illustrated components may be interconnected via the data bus 500. However, for purposes of the present description, they may be illustrated as being directly connected.

Arithmetic operations and issuance of control signals are performed by the CPU 42. The CPU 42 includes a program memory 504 and a data memory 506. The CPU 42 also comprises a master clock 510. The master clock 510 comprises a form of clock 301 of FIG. 3. The master clock 510 provides timing for CPU operations, duration of each stage of each auction, and bid countdown timers. The master clock 510 is coupled to an auction counter 518. The auction counter 518 includes an up counter 520, a stage counter 522, and a bid window counter 524. The stage counter 522 and the bid window counter 524 are down counters. The up counter 520 measures the duration of an auction. The stage down counter 522 determines the duration of stages which have a set time duration. The bid window down counter 524 determines the maximum length of time a bid window will stay open in the absence of a bid. The server module 30 may run a plurality of auctions concurrently. A separate section of the auction counter 518 is provided for each separate auction.

Users 10 may register with the auction company 62 (FIG. 1) and their user information will be stored in a user database 536. The user database 536 may include a plurality of user profile locations 538 each associated with a respective user 10. Each user profile location 538 may have a multitude of fields a-g with descriptive data to be used in association with one respective user 10. These fields may include 538a—username, 538b—user e-mail address, 538c—user default address for a shipment of auctioned items, 538d—payment information such as credit card, PayPal® account, or checking account number, 538e—user preferences for notification of upcoming auction, 538f—user history, and 538g—account balance as Auction Passes. Each user profile location 538 is password protected.

An auction database 540 may be provided to store and make accessible information regarding past, present, and future auctions. The auction database 540 may be loaded with information by the management module 60. The auction database 540 includes storage sections 542 each corresponding to one auction. In one illustrative embodiment, each section 542 includes identity field 542a—storing a description of each auction, entry fee field 542b—storing the number of auction passes needed for entry to an auction, item field 542c—describing particular items being auctioned and opening prices, tags field 542d—in order to make auctions searchable by subject matter, cross reference field 542e—containing cross reference information to other auctions, link field 542f—containing links to information, and field 542g—the identification number of the auction. This information may include the bid values, new user discounts and stage duration, which can be stored in the auction register 580 further discussed below. Links can be provided to locations providing information on subjects such as manufacturer history, consumer ratings, product support resources, or other areas. The databases 536 and 540 are illustrated as discrete components for purposes of the description. However, they do not need to be separate components.

A user register 560 stores data associated with respective users 10. The user register 560 may comprise a plurality of user locations 562. One user location 562 is associated with one respective user 10. Each user location 562 comprises a plurality of fields. The fields include at least enough locations to provide access to the data used in the steps described with respect to FIGS. 3, 4, and 5. In the illustration of FIG. 6, one user location 562 comprises a field 562a—monetary balance, 562b—auction pass balance, 562c—bid balance per auction, and 562d—number of auctions currently entered. Each user location 562 may be loaded via the CPU 42. Information may be loaded from one or a combination of the management module 60, user module 10, and data accessed from the user database 536. The account for each user comprises the number of auction passes purchased by the respective user, cash balance, if any, on a user account, and the number of bids a user has for a current auction.

An auction register 580 registers the current status of all auctions. The auction register 580 may comprise a plurality of auction locations 582. One auction location 582 is associated with one respective auction. In one form, an auction location 582 comprises a field 582a—name of auction, 582b—current stage and time remaining in the stage, 582c—current auction price, 582d—auctioned item, or, optionally, the item selected from an auctioned group if the winning bidder has chosen one, and 582e—current winner. All items in a respective Auction Pass Level are stored in the auction database 540. Each auction location 582 may be loaded via the CPU 42. Information may be loaded from one or both of the management module 60 and the auction database 540.

A bid detector 600 is provided to respond to inputs from users 10 indicative of bids. The bid detector 600 receives inputs coupled by the CPU 42 in response to the submission of a bid from the user 10. The bid detector 600 issues signals in response to a bid in order to reset the bid window timer, adjust a bidder's bid balance, and decrement the auction price. The user detector 630 issues a signal indicative of a first user joining the auction, as indicated at block 312 in FIG. 3. This signal is not indicative of an actual bid placed by a user, since the auction price is not reduced and no bid is removed from the user's balance. Alternatively, this may be described as the first user having a “free” bid placed.

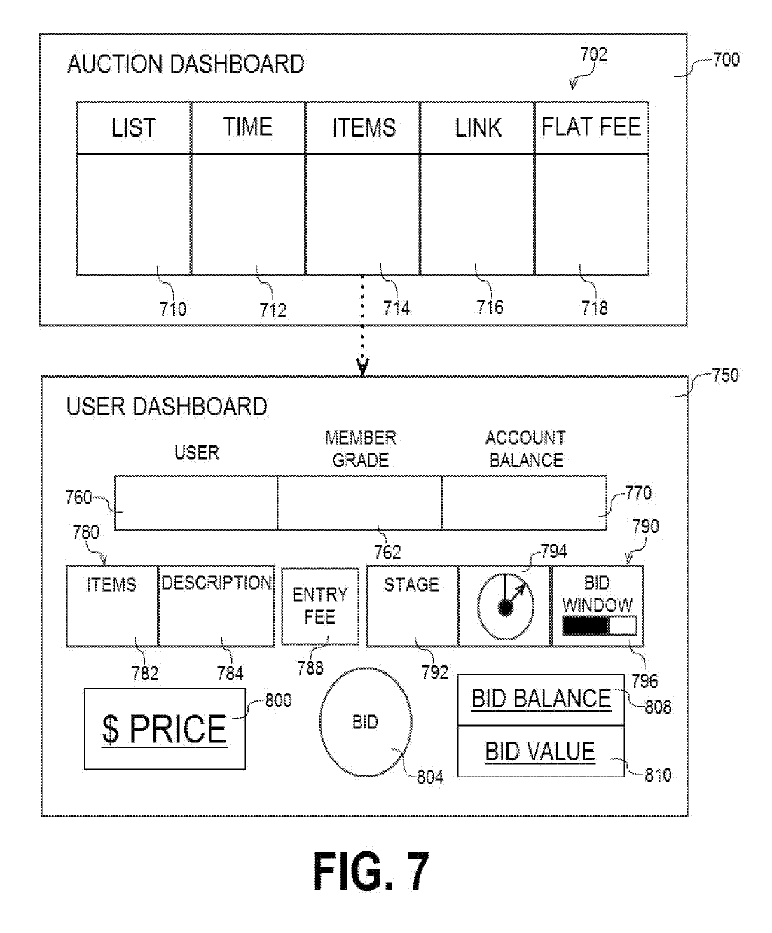

FIG. 7 is a diagram of an auction dashboard 700 through which users 10 may gain information about current and pending auctions and interact with the server module 30. In one preferred embodiment the auction dashboard 700 comprises a graphical user interface (GUI) interacting with a webpage of an auction company 62. The auction dashboard 700 may have virtually any number of fields. No one particular set of fields must be provided in implementing the current subject matter. However, in a preferred embodiment, it is useful to provide fields which will enable a user to make a decision as to becoming an entrant, and to schedule future participation. Many forms of a field 702 may be provided. In the current description, a field 702 is shown as being located in full on the auction dashboard 700. In the present embodiment, the field 702 comprises the auction schedule. Within field 702 are included fields 710, 712, 714, 716, and 718.

Field 710 lists dates of upcoming auctions. Field 712 lists a schedule of times corresponding to each auction listed in field 710. First, second and third information fields 714, 716, and 718 provide information regarding a respective auction. The first information field 714 could, for example, list a title for the auction or a general indication of the type of item being auctioned. The second information field 716 may comprise a link to detailed descriptions of the items in a lot. The third information field 718 may comprise a list of fees for entry into each auction. As further described below, auctions will each have a flat entry fee. A user 10 may select links from field 716, which will direct users to further information regarding the auction or to begin the process of entering the auction.

A user 10 may select a dashboard link at field 716 which will lead to another webpage. This webpage is referred to as a user dashboard 750, as seen in FIG. 7. The user dashboard 750 contains fields to inform a user 10 about the options for entering an auction, and for informing a user-entrant of the current status and options regarding auction participation. No one particular set of fields is essential for inclusion on the user dashboard 750. A sufficient number of fields needs to be provided to allow a user to participate in a manner further described below. The user dashboard may provide information regarding one or more of the Join Auction Pop-Up Window, the Auction Bid Page, or other auction information.

In the present illustration, a field 760 lists a user's identity. The identity will commonly be provided by the user during a conventional registration process. Field 762 is a descriptor calculated by the auction company to encourage loyalty by users. Such a descriptor could be “gold level member,” or “auction expert.” Field 770 displays the monetary value of a user's account balance, which could be in terms of monetary units, points, or in units particular to the vocabulary of the auction process, each unit having a particular monetary value.

Field 780 comprises an auction catalog and contains a general description of a current auction. Included in field 780 are fields 782 and 784. Field 782 lists an item for auction, and field 784 describes the item. The winner may make a selection after reviewing fields 782 and 784. Field 788 lists the price of flat fee entry into the current auction.

Field 790 lists operational parameters of an auction. These parameters include a number of stages, each stage having its own total time span, bid window duration, permissions, and the effect each bid has on the auction price. Any number of these parameters may be included. In the present illustration, the field 790 comprises fields 792, 794, and 796. Field 792 may comprise an indicator of current stage of the auction. Field 794 may indicate the time remaining in a current stage. Field 796 shows time remaining in a current bid window.

Field 800 discloses a current auction price. Field 804 is a button, which a user 10 may activate to submit a bid, and field 808 is a table showing a user's remaining bids in the current auction. A field 810 displays the current bid value.

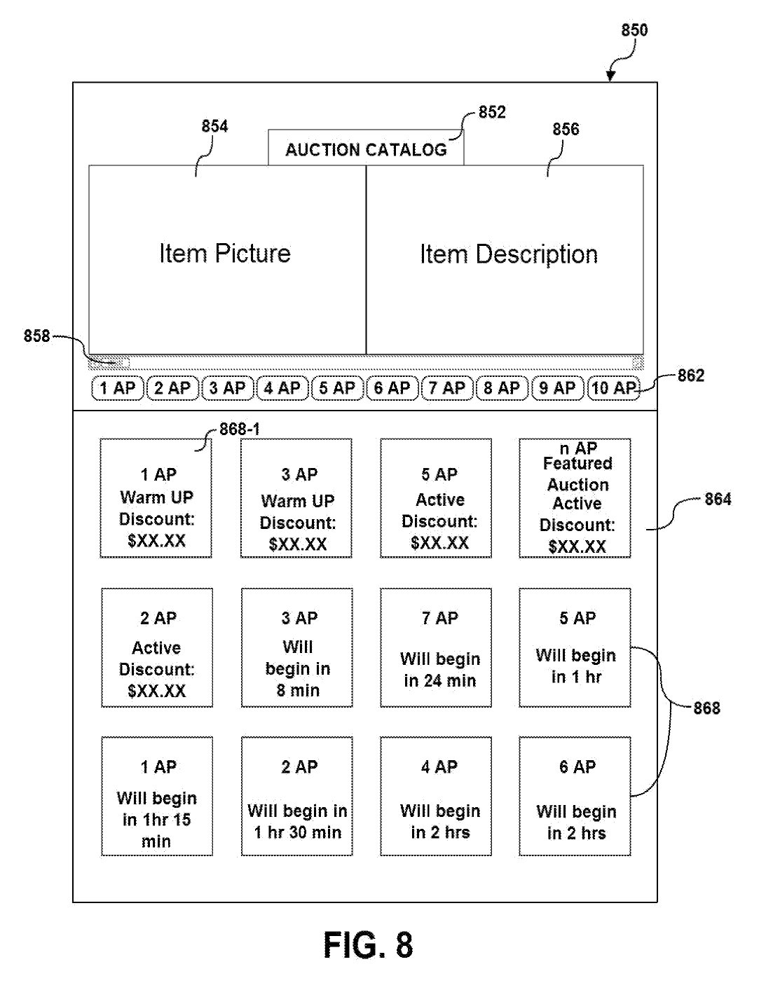

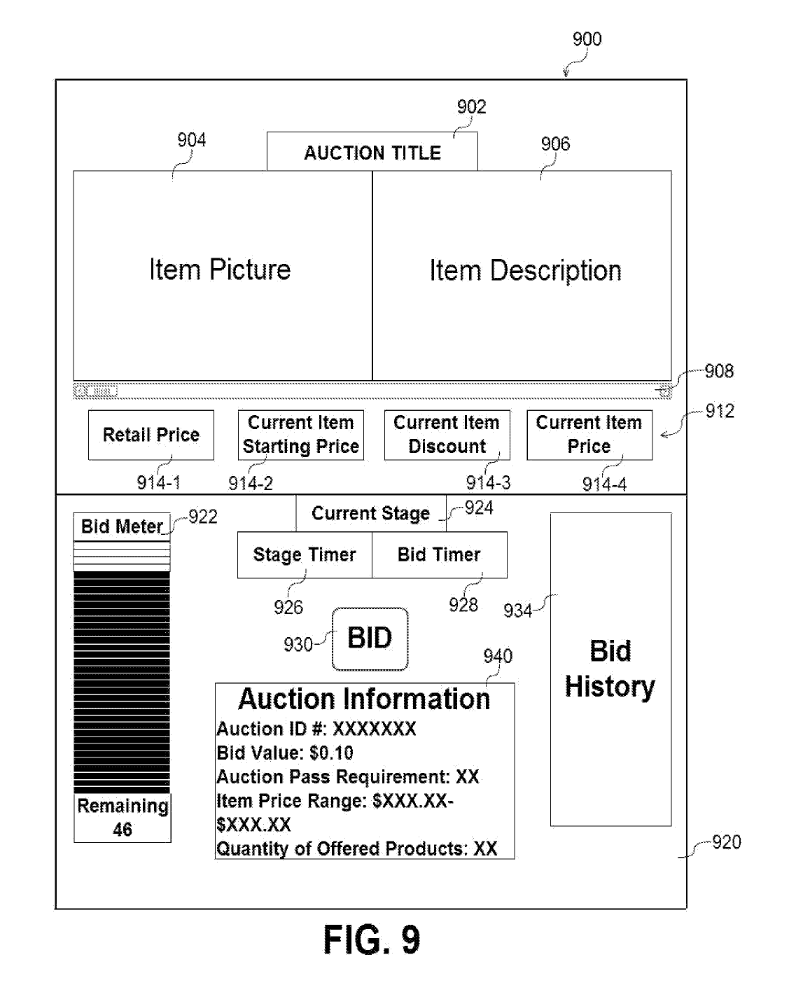

FIGS. 8 and 9 represent an alternative to the embodiment of FIG. 7. FIG. 8 is an illustration of an auction home page 850 that can be accessed by each user 10. The auction home page 850 provides access to a display of all the items offered in the auction catalog listed in the auction database 540. A field 852 contains the title “Auction Catalog.” An auction pass selection bar 862 contains selections of the different auction pass levels. A user 10 may select one of the choices listed in the auction pass selection bar 862. The identity of a selected auction pass level will be identified by a highlighted button on the auction pass selection bar 862. A scrollbar 858 is provided to allow users 10 to scroll through different items. In a preferred form, the scrollbar 858 can be used to scroll through different items under each auction pass level. An item picture and an item description are contained in fields 854 and 856 respectively.

An auction access field 864 contains a plurality of selection boxes 868. In the present illustration, the auction access field 864 contains selection boxes 868-1 through 868-12. Selection box 868-1 displays an auction entry fee in units of auction passes. Temporal auction status is also displayed. The display may list the time remaining until the start of a particular auction or the current stage of an auction in progress. A current discount, new user discount, and duration of each stage are also displayed. Featured Auctions tiles are displayed differently than Normal Auction tiles. For example, instead of the Auction Pass Level being the title of the auction, Featured Auctions will display the name of the item as the auction's title. Featured Auctions will also include the Auction Pass requirement on the auction tiles. The Auction Pass requirement will be nAP where n is an integer.

FIG. 9 is an illustration of an auction bid page 900. A field 902 shows the title of the currently selected auction. Fields 904 and 906 respectively display a picture and a description of the items in a current auction. A view of an item to be auctioned may be selected by scrolling through a scrollbar 908. A price field 912 includes price displays 914-1 through 914-4. These displays illustrate respectively retail price of an auctioned item, current auction starting price for the item, current item discount price, and current auction price. Retail price, starting price, and current auction price will change with a change in a selected item. A status field 920 includes a bid meter 922 which registers a current number of bids, a current stage indicator 924, a stage timer 926, and a bid window, elapsed time display 928. A bid selector 930 may be accessed by a user 10 to enter a bid. The bid history is illustrated in a display field 934. The display field 934 will not be active until the Lockout Stage. An auction information field 940 may provide an auction identification number, a value of a price decrement for each bid, the auction pass entry fee, item price range, which corresponds to a current auction pass level, and the quantity of offered products from which the winning bidder selects one product.

### Rules

An auction is conducted in accordance with rules. Rules are implemented physically by the software corresponding to FIGS. 1-5, and by the hardware in FIG. 6. Rules may be set by the auction company by the operation of the management module 60. One set of rules that may be used is as follows.

Each user 10 will be credited 50 bids upon joining an auction. The auctioned item will begin at 75% of its retail price. This is the “item auction price.” Each bid that is placed will reduce the item auction price by $0.05-$0.25, depending on the number of required auction passes. As more bids are placed, the auction price is decremented. A bid window timer is reset each time a bid is placed. The duration of the bid window timer will gradually decrease as the auction progresses. The winning user is the last user to place a bid before the bid window timer expires. The winning user claims the auctioned item by paying the final item auction price. If a winning user is not satisfied with the final item auction price, the purchase may be declined, and the user may receive double auction passes in return.

### Additional Rules Include:

1. A user cannot bid more than once in succession. For example, a user would not be able to bid 50 consecutive times on an auction to drive down the auction price. Another participant must place a bid before the first user is allowed to bid again. This is achieved, for example, by identifying bids at the bid detector 600 which are tagged with a user 10's identity. If two bids in succession have the same user identity tag, the second is not transmitted by the bid detector 600 via the CPU 42 (FIG. 1).
2. A user can only partake in six auctions at one time. When a user 10 enters an auction, the user detector 630 provides input to the user register 560, and more particularly to the user register location corresponding to the respective user 10. When the user register detects that any user 10 has entered six auctions, the user register 560 provides a signal to the CPU 42 which is used to block the entry of the respective user 10 into additional auctions, until the user's auction count decreases below six auctions.
3. The first user to join an auction will have a bid automatically placed for him. The bid detector 600 senses a first bid and sends a signal to auction register 580. This bid will not reduce the item auction price, and it will not be deducted from the user's bid count. This will ensure that there will be a winner in the rare event that there are participants, but the first bid window timer expires before a bid is placed.
4. Once the users have spent all their bids on an auction, they will not be allowed to “Buy Back In.”
5. If no participants join an auction when the Warm Up timer expires, the auction will be void, and no winner will be produced, as illustrated with Block 316 in FIG. 3.

### Auction Stages and Timers

Each auction will have three stages. The duration of the first two stages may be determined by the retail price of the item. Auctions of more expensive items may have longer stages. The stages will consist of the following:

Warm Up Stage: This stage will occur immediately when the auction opens to users. It will be a 15-45 minute period when users can join an auction without an active bid window timer. The duration of the stage may depend on the price of the item. In addition, each new user that joins during this stage will automatically decrease the item auction price by 0.5% of the item's retail price. This is known as the “New User Discount.” This discount will be deducted at the end of the Warm Up period. Participants will be allowed to bid to drive the item auction price down. However, there can be no winner during this stage since there is no active bid window timer. The time remaining in the Warm Up Stage will be displayed via the “Warm Up Timer.”

Active Stage: After the Warm Up period has ended, the 30-120 minute Active Stage will begin. The duration of the stage may depend on the price of the item. During this stage the bid window timer will become active, and allow the auction to produce a winner. This bid window timer will remain active for the duration of the auction. The bid window timer will function the same as a Penny Auction bid window timer. Each time a participant places a bid, the bid window timer will reset. The bid window timer will begin with a 15 second duration. The bid window timer will reduce to 10 seconds halfway through the Lockout Timer. When the Lockout Timer expires, the bid window timer will be 5 Seconds, and remain this way for the remainder of the auction. Other durations may be selected. Users will still be allowed to join during this stage, however, they will not receive the New User Discount when they join the auction. The time remaining in the Active Stage will be displayed as the “Lockout Timer.”

Lockout Stage: When the Active Stage ends, users will no longer be allowed to join the auction. The auction will also be removed from the auction homepage. This period will be known as the Lockout Stage. The bid window timer will remain active, and the users already participating in the auction will continue to bid and try to win the auction. In a preferred form, during the Lockout Stage, a bid duration will be 5 seconds. The 5 second duration begins at the start of the Lockout stage. This duration will not change for the remainder of the auction. Beginning in this stage, each participant's username will be displayed as they bid. The Lockout Stage has no time limit. It will only end if the bid window timer expires, and a winner is produced.

### Auction Statuses

The Auction Statuses should be displayed on all auction tiles and on the Auction bid pages. It will allow users to know the current stage of each auction. “Inactive” auctions are auctions that have not started. “Warm up” auctions are currently in the Warm Up Stage. “Active” auctions are all auctions that are currently in the Active Stage. “Locked” auctions are those that are currently in the Lockout Stage. “Completed” auctions have ended.

### User Information Hidden or Displayed

User information will not be displayed until the auction has locked. This includes the quantity of participants, the names of users that place a bid, and the number of bids remaining. This will ensure that participants who join early will not have an unfair advantage by counting other users' bids. However, once the auction “Locks,” it will begin to display the usernames of participants as they place bids. Despite seeing the usernames of each bidder, there is no way to know exactly how many bids each participant has remaining. Although, each participant will be able to estimate how many bids their competitors have remaining. It will make the auctions more interesting during the “End Game,” since participants will be able to see the bids placed by each competitor. This feature will add to the competitive appeal of the auctions, and prompt users to make strategic decisions about when to place each bid.

A “Log” of participant activity is displayed on the Auction Review Page to provide information disclosure to auction participants. It will consist of all bids placed and the users that placed the bid, time the bid was placed, respective user's remaining bids, when each user joins the auction, winning bidder's username, total bids placed, final item auction price, new user discounts, and the total duration of the auction.

### Normal and Featured Auctions

Normal Auctions are auctions that allow the winning user to choose the item they win from the auction catalog. In Featured Auctions, one preselected item is auctioned. Featured Auctions will be displayed in the same format as Normal Auctions. However, since there is only one offered item, users will not be able to scroll through the auction catalog. Information regarding a featured item may include a picture of the item, name of the item, item description, and retail price.

Featured Auctions will display the item name as its title, and Normal Auctions will display the Auction Pass Level. Featured and Normal Auctions may also display the auction pass level, auction passes required, retail price (Featured) or price range corresponding to the auction pass level (Normal), bid value, and starting item auction price (Featured).

### Auction Passes, Auction Pass Levels, and Bid Values

Users can select the “Auction Passes” button on the top menu bar to be directed to the “Buy Auction Passes” page to purchase auction pass packages. The page will display the offered packages, and allow the user to select the package they wish to purchase. The page will display all the Auction Pass packages in tiles (buttons) that the user can select. The tiles will also display the discount on larger Auction Pass packages when applicable.

Once the package is selected, they will be routed to PayPal® or other online payment portal where they can finalize their purchase. When the purchase is complete, the user's account will instantly be credited the Auction Passes.

Auction Pass packages will be in the following increments:
1: $5
5: $23, an 8% discount
10: $44, a 12% discount
20: $84, a 16% discount
50: $200, a 20% discount

Users will use a specified number of Auction Passes to join an auction. The following are the items' retail price ranges associated with each Auction Pass level:
1 Auction Passes: $0-$100
2 Auction Passes: $101-$200
3 Auction Passes: $201-$350
4 Auction Passes: $351-$500
5 Auction Passes: $501-$700
6 Auction Passes: $701-$900
7 Auction Passes: $901-$1150
8 Auction Passes: $1151-$1400
9 Auction Passes: $1401-$1700
10 Auction Passes: $1701-$2000

The more Auction Passes required to participate in an auction, the greater the value of each bid, “Bid Value.” Each Bid will reduce the price of an auctioned item by $0.05-$0.25. Below is a list of the entry fees and associated price decrements per bid.
1 Auction Passes: $0.05
2 Auction Passes: $0.05
3 Auction Passes: $0.10
4 Auction Passes: $0.10
5 Auction Passes: $0.15
6 Auction Passes: $0.15
7 Auction Passes: $0.20
8 Auction Passes: $0.20
9 Auction Passes: $0.25
10 Auction Passes: $0.25
   The number of auction passes required, the auction pass prices, auction pass levels, and bid values may change, and are set by the auction company 62 (FIG. 1).

### Auction Examples

An item with a retail price of $200 will begin at $150 (75%), the starting item auction price. The auction will cost two auction passes to participate. Each new user that joins during the Warm Up Stage will decrease the price of the item by 0.5% of the retail value of the item, which is represented by the following equation (0.5%*$200=$1). Therefore if there are 15 users who join during the Warm Up Stage, each will decrease the item auction price by $1, for a total of $15. The item auction price will now be at $135. On auctions that require two Auction Passes, each bid will reduce the item auction price by $0.05. If no other users join the auction, the 15 users with 50 bids each can lower the item auction price a maximum of $37.50 (15 users*50 bids*$0.05=$37.50). The cheapest a $200 item can be auctioned for with 15 users is $97.50. If all bids are spent in this scenario, the winning user will win the $200 item for $107.50 ($97.50 item auction price+$10 flat fee). This is a little less than a 50% discount. The 14 losing users only lose $10 each, and the auction company 62 will make $247.50 ($97.50 item auction price+$150 in flat rate fees), for a profit of $47.50. In the current illustration, the profit is based on the excess over retail price. Other ways to measure profit may be used, as items may be purchased by the auction company 62 below the item's retail price.

Additional information that may be provided via the user dashboard 750 may include an auction catalog, auction schedule, auction overview, and bid transfers.

### Auction Catalog

An auction may be conducted with respect to a group of items. The auctioned item may be an item selected from the Auction Catalog by the winning user.

The auction catalog on the auction homepage and user homepage will have buttons below the auction catalog, allowing the user to select the different auction pass levels. This will allow users to view the items in the respective Auction Pass Levels, before they join an auction.

Auctions on individual Auction bid pages will only include the items for that auction pass level. There will be no buttons beneath the auction catalog to select different auction pass levels. The auction catalog will allow users to scroll through the different items and information. The auction catalog will be designed similar to the iTunes Album scroll feature. The value of all bids placed and “New User Discounts” will be tallied and displayed as a negative number, the “discount price.” The Item's starting price will be subtracted by the discount price to calculate the item auction price.

The starting price and item auction price will change with each item in the auction catalog, but the discount price will be the same. During an auction, the retail price, starting price, and current item auction price will change as a user scrolls between the different items in the auction catalog. These parameters will be displayed for all users.

The auction catalog includes a “Bookmark” function. This allows users to tag the items they are interested in, and easily find them.

### Auction Schedule

The Auction Schedule will display all auctions for the next seven days in chronological order by timeslot and include relevant auction information. This page will be accessed by a button on the auction homepage. The table will list the auctions by date and day of the week.

A user can click on any of these days to expand the table which will now display, in chronological order, the auctions available for that day. The expanded table will display Auction Time, Auction ID#, Name of Auction (link to “Preview Page”), and Auction Type (Featured or Normal).

### Auction Overview

The Auction Overview will be located on the user homepage. It will display the auctions the user is currently participating in. Under one set of rules the maximum is six. The Auction Overview will be displayed in a tiled format, similar to the Auction Table, allowing the user to manage all his auctions from one web page. However, the tiles should be bigger as they will contain more information.

Essentially the tiles will be a miniature version of the “auction home page,” containing: a picture of the item (Featured) or auction pass level (Normal), title of the auction, auction ID #, bid window timer (if activated), bid value, current discount price, “warm up” or “lockout” timer, the user's remaining bids, auction type, and bid button. Other information may be left out.

If a user joins an auction, it will automatically be added to the “Auction Overview” table and when the auction is finished or the user runs out of bids, and the user is not the last person to bid, it will remove the auction from the table. If a user clicks on the picture of the item, it will direct them to the auction's bid page. Users can view the information that was omitted via the auction bid page.

### Bid Transfer

One set of rules states that users may transfer bids to a future auction free of charge, this is known as the Bid Transfer feature. The user must use this feature before the auction ends. Users will not be able to use the transferred bids until the original auction is complete. When a user applies the bids to a new auction, they will only receive the amount of bids they transfer. For example, if a user has 17 bids remaining and they decide to transfer this to another auction, they will only have 17 bids for that new auction. They will only be able to use this feature on a new auction that requires an equal or lesser number of Auction Passes than the original auction, but there will be no additional cost for using the Bid Transfer. Only one Bid Transfer can be held at a time (may be increased). Bids will not stack. Users will not be able to add transferred bids to an auction they are already participating in. The purpose of this feature is to protect users with time constraints. An auction may go on for several hours, depending on the number of users and required Auction Passes, and a user may have to leave before the auction finishes. This feature will prevent users from wasting their Auction Passes if they have to leave the auction before it is complete.

### Special Auctions

The auction company 62 will offer several Special Auctions for users that will either change the way the auction operates or offer unique prizes for winning the auction.

Auction Pass Auctions: These are auctions for auction passes. Once the winning user pays the item auction price, the user's account will instantly be credited the auction passes. The auctioned quantities may include: 5, 10, and 20 auction passes.

Qualifying Auctions: These auctions are designed for high priced items. It will consist of two parts, the first are the “Qualifying Auctions,” and the second is the “Final Auction.” There will be several qualifying auctions, and users must win one to participate in the Final Auction. The Final Auction will include all the winners from the Qualifying Auctions, and they will compete for the Grand Prize. Multiple Qualifying Auction levels, i.e. a semifinal round, to increase the number of Qualifying Auctions may be offered.

Qualifying Auctions will behave exactly the same as normal Flat Rate Auctions. Users will be credited 50 bids. The starting price of Qualifying Auctions will begin at $50, and decrease in price like a normal auction. Users will be able to participate in as many unique Qualifying Auctions as they want, but they can only win once. If a user has already won a Qualifying Auction, the user will be locked out of future Qualifying Auctions. Users will be credited Auction Passes in addition to the right to participate in the Final Auction. The winning user must pay the Final item auction price to claim the Auction Passes, but is not required to pay anything to participate in the Final Auction.

Final Auctions: There will be no Auction Pass requirement for the Final Auction. If a user has won a Qualifying Auction, the user will be able to join the Final Auction at no additional cost. The Final Auction will be scheduled for a later date so users can determine whether or not they can participate in the Final Auction. There are several differences between a Final Auction and a Flat Rate Auction, including; only users that win a Qualifying Auction can participate in the Final Auction. Users will be credited the quantity of bids they have remaining from the Qualifying Auction, plus an additional 10 bids. For example, if the user spent 12 bids in the Qualifying Auction, the user will be credited the 38 bids left over plus 10 additional bids, for a total of 48 bids. There will be no Warm up Period, but users will be allowed to join the auction before it becomes active. The username of users will be displayed from the beginning of the Final Auction. There will be no item auction price, or price decrease. The last person to bid is the winner, and the winner does not have to pay to claim the prize.

### Flat Rate Auction Bidding Process

A user will have to be logged in to join an auction. The user will then click the “Auctions” button located on the top menu bar. The user will now be directed to the “auction homepage.” The user can observe an auction by selecting the respective auction's tile, or the user can join an auction immediately by pressing the “Join” button. If the user selects an auction tile, it will direct them to the Auction Preview page.

There are two types of Auction Preview pages, depending on whether the auction is Open or Inactive. If the auction is Open, the user can observe the auction, but will not be able to participate in the auction. The “Bid” button will be replaced with a “Join” button so users can join the auction. If the auction is Inactive, the user will be able to view the auction's details, but there will be no Bid or Join buttons.

The “Join” button will open the “Join Auction” popup window which will ask the user if the user wants to join the auction. The Join Auction popup window can be reached from many pages (i.e. auction homepage, user homepage, or any other page with a “Join Auction” button linked to a specific auction.) If the user agrees to join the auction, the auction passes will be deducted from the user's account, and the user will be directed to the “auction bid page.”

Once an auction is complete, the auction bid page will convert to the Auction Review Page. The Auction Review Page will be a summary of the completed auction. The user that won the auction can claim their item in their User Account Page, “Won Auction” section, or via the respective Auction Review Page. If it is a Normal Auction, the user must first choose the item the user wants from the Auction Catalog. Featured Auctions already have the item determined. The user will then be able to pay for the item through online payment.

If the user does not find the final item auction price satisfactory, the user will have the option at the conclusion of the auction to void the auction. The user does not need to pay the final item auction price, and will give up the right to the item that was won. However, the user will receive double the Auction Passes that the user spent as a reward for winning the auction. The Auction Passes used by other users will not be refunded.

Once payment is complete, a confirmation email will be sent to the user. This will be in the form of a receipt and users will be instructed to save this email for their financial records. A confirmation email will be sent when the item has been shipped including shipping information and package tracking numbers.

While the foregoing written description of the present subject matter enables one of ordinary skill to make and use what is considered presently to be the best mode thereof, those of ordinary skill will understand and appreciate the existence of variations, combinations, and equivalents of the specific embodiment, method, and examples herein. The present subject matter should therefore not be limited by the above described embodiment, method, and examples, but by all embodiments and methods within the scope and spirit of the present subject matter.

What is claimed is:

1. A method for conducting an electronic auction comprising the steps of:
providing a server comprising a database housing data for auction parameters, and wherein said server is coupled to communicate with a plurality of remote user locations;
setting a fixed entry fee for an auction;
crediting a user with an initial bid balance of a fixed number of bids for use in an auction in response to the user's payment of the fixed entry fee;
setting an initial auction price for an auctioned item;
registering entry of a first user into the auction and setting the initial auction price as a current auction price in response to the entry;
setting a bid window having a preselected time duration;
enabling the receiving of bids entered by users;
in response to each bid decrementing the current auction price by a preselected amount and decrementing the respective user's bid balance, and restarting the bid window;
setting a rule for ending the auction, the rule including a parameter having a value which is a function receipt or non-receipt of a bid during a bid window; and
ending the auction when conditions of the rule are met.

2. A method according to claim 1, wherein the step of decrementing the current auction price by a preselected amount in response to each bid comprises allowing the current auction price to be decremented below a zero value.

3. A method according to claim 1 wherein the step of registering the entry of a first user into the auction further comprises attributing a bid to the first user and without decrementing the first user's bid balance.

4. A method according to claim 1 wherein the step of crediting a user with an initial bid balance of a fixed number of bids comprises disabling a user from purchasing additional bids during the auction.

5. A method according to claim 1 wherein the step of enabling receiving of bids entered by users comprises requiring receipt of a bid by another user in order to enable a user to make a next bid.

6. A method according to claim 1 further comprising the step of setting an initial time period and canceling the auction in response to failure to register entry of a first user during the first time period.

7. A method according to claim 1 further comprising providing an auctioned item comprising a set of items from which a winning bidder will select at least one item and further comprising registering a selection of a winning bidder.

8. A method according to claim 1, further comprises dividing the auction into a plurality of temporally successive stages, each stage having a different rule for ending the stage.

9. A method according to claim 8 wherein the step of dividing the auction into a plurality of temporally successive stages comprises establishing a first period during which bids may be placed and in which the rule for ending the stage comprises ending the stage at the end of a preselected time period.

10. A method according to claim 9 wherein the step of dividing the auction into a plurality of temporally successive stages comprises establishing an active stage having a preselected duration and defining bid windows, each bid window having a preselected duration during which a bid may be placed and in which the rule for ending this stage comprises sensing absence of placement of a bid during a bid window or expiration of the duration of the active stage.

11. A method according to claim 10 further comprising beginning the active stage at the end of the first stage.

12. A method according to claim 11 wherein the step of dividing the auction into a plurality of temporally successive stages comprises establishing a final stage, blocking new users from joining the auction, defining bid windows, each bid window having a preselected duration during which a bid may be placed and in which the rule for ending the final stage comprises sensing absence of placement of a bid during a bid window.

13. A method according to claim 12 wherein the final stage further comprises displaying to users identity and time of other users placing bids.

14. A method according to claim 13 wherein the step of establishing a bid window duration comprises establishing a set of bid window duration values and selecting one bid window value at each of a plurality of preselected times during a stage.

15. A method according to claim 14 wherein the step of ending the auction comprises entering an end routine and wherein the end routine comprises displaying auction data to users and conducting order fulfillment for a winning bidder.

16. A method according to claim 15 further comprising the step of registering a number of auctions in which a user account is currently entered and setting a maximum number of auctions which a user is permitted to be entered in at one time.

17. A method according to claim 16 further comprising the steps of registering a number of bids in a user account and setting a rule based permission for allowing a bid balance to be transferred to a bid balance of the user in another auction.

18. A non-transitory machine-readable medium that provides instructions, which when executed by a processor, causes said processor to perform operations comprising:
setting a fixed entry fee for an auction;
crediting a user with an initial bid balance of a fixed number of bids for use in an auction in response to the user's payment of the fixed entry fee;
setting an initial auction price for an auctioned item;
registering entry of a first user into the auction and setting the initial auction price as a current auction price in response to the entry;
setting a bid window having a preselected time duration;
enabling the receiving of bids entered by users;
in response to each bid decrementing the current auction price by a preselected amount and decrementing the respective user's bid balance, and restarting the bid window;
setting a rule for ending the auction, the rule including a parameter having a value which is a function receipt or non-receipt of a bid during a bid window; and
ending the auction when conditions of the rule are met.

19. A non-transitory machine-readable medium according to claim 18 wherein operations further comprise commanding initiation of a plurality of temporally successive stages, each stage having a different rule for ending the stage.

20. A non-transitory machine-readable medium according to claim 19 wherein the operation of dividing the auction into a plurality of temporally successive stages comprises establishing a first period during which bids may be placed and in which the stage is ended when the duration of the stage equals a preselected value.

21. A non-transitory machine-readable medium according to claim 20 wherein the operation of dividing the auction into a plurality of temporally successive stages comprises establishing an active stage having a preselected duration and defining bid windows, each bid window having a preselected duration during which a bid may be placed and in which the rule for ending this stage comprises sensing absence of placement of a bid during a bid window or expiration of the duration of the active stage.

22. A non-transitory machine-readable medium according to claim 21 further performing the operation of beginning the active stage at the end of the first stage.

23. A non-transitory machine-readable medium according to claim 22 wherein the operation of dividing the auction into a plurality of temporally successive stages comprises establishing a final stage, blocking new users from joining the auction, defining bid windows, each bid window having a preselected duration during which a bid may be placed and in which the rule for ending the final stage comprises sensing absence of placement of a bid during a bid window.

24. A non-transitory machine-readable medium according to claim 23 wherein the operation of conducting the final stage further comprises displaying to users identity and time of other users placing bids.

25. A non-transitory machine-readable medium according to claim 24 wherein the operation of establishing a bid window duration comprises establishing a set of bid window duration values, clocking the elapsed time of a stage and selecting one bid window duration value for each of a plurality of preselected clock intervals.

26. A non-transitory machine-readable medium according to claim 25 wherein the operation of ending the auction comprises entering an end routine and wherein the end routine comprises displaying auction data to users and conducting order fulfillment for a winning bidder.

27. A non-transitory machine-readable medium according to claim 26 further causing the processor to initiate the operations of establishing a display of scheduled auctions accessible to users and of selectively displaying auctioned items associated with each auction.

28. A non-transitory machine-readable medium that provides instructions, which when executed by a processor, causes said processor to perform operations comprising:
setting a fixed entry fee for an auction;
crediting a user with an initial bid balance of a fixed number of bids for use in an auction in response to the user's payment of the fixed entry fee and disabling the user from purchasing additional bids during the auction;
setting an initial auction price for an auctioned item;
setting a bid value by which the auction price will be decremented in response to a bid;
registering entry of a first user into the auction and setting the initial auction price as a current auction price in response to the entry and attributing a bid to the first user without decrementing the first user's bid balance;
setting a bid window having a preselected time duration;
enabling the receiving of bids entered by users;
in response to each bid decrementing the current auction price by a preselected amount and decrementing the respective user's bid balance, and restarting the bid window;
setting a rule for ending the auction, the rule including a parameter having a value which is a function receipt or non-receipt of a bid during a bid window; and
ending the auction when conditions of the rule are met.

29. A system for conducting an electronic auction comprising:
a server comprising a database housing data for auction parameters, and wherein said server is coupled to communicate with a plurality of remote user locations;
an entry fee register storing a value defining a flat entry fee for an auction and having a sensing circuit to allow a maximum of one entry fee per user per auction;
a user bid balance register coupled to be incremented to a preselected bid balance for a selected auction in response to payment of the flat entry fee;
auction price register for an auctioned item initially settable to register an initial auction price;
a selection circuit actuatable by a user to request entry into an auction;
a register circuit responsive to actuation of the selection circuit by a user to decrement a user account by an amount equal to the value in the entry fee register;
a bid detector registering entry of a first user into the auction and setting the initial auction price as a current auction price in response to the entry;
the bid detector further comprising a register coupled for preventing consecutive bids from one user;
an auction price register coupled to decrement the current auction price by a preselected amount in response to outputs of said bid detector; and
a rule-based comparator for ending the auction which is enabled to issue a signal commanding an end routine when conditions of the rule are met.

30. A system according to claim 29 further comprising a clock and a register responsive to said clock to provide a signal to enable the start of successive auction stages at preselected clock times.

31. A system according to claim 30 further comprising a bid window register responsive to said clock to provide a signal to enable receipt of a bid from a user during a preselected interval.

32. A system according to claim 31 further comprising a timer operated by said clock, which timer is settable for defining a warm up period duration.

33. A system according to claim 32 wherein a timing circuit defines the active stage having a preselected duration and defines bid windows and in which the rule-based comparator senses absence of placement of a bid during a bid window or expiration of the duration of the active stage.

34. A system according to claim 33 wherein one said stage is a final stage, and further comprising a circuit responsive to said clock to block new users from joining the auction in the final stage, and in which the rule-based comparator senses absence of placement of a bid during a bid window, the system further comprising a coupling circuit providing information to users indicative of bids by other users in response to initiation of the final stage.

35. A system according to claim 34 wherein the bid window register stores a set of bid window duration values and in which one bid window value is accessed to define bid window duration, and in which the bid window duration value is selected in correspondence with preselected clock times.

36. A system according to claim 35 further comprising an auction database for enabling display of scheduled auctions accessible to users and of selectively displaying auctioned items associated with each auction.
